(19) United States
(12) Patent Application Publication
(10) Pub. No.: US 2012/0219308 A1
(43) Pub. Date: Aug. 30, 2012

(54) FIXING DEVICE AND IMAGE FORMING APPARATUS

(75) Inventor: Mamoru FUKAYA, Nagoya-shi (JP)

(73) Assignee: Konica Minolta Business Technologies, Inc., Chiyoda-ku (JP)

(21) Appl. No.: 13/401,307

(22) Filed: Feb. 21, 2012

(30) Foreign Application Priority Data
Feb. 25, 2011 (JP) 2011-040520

(51) Int. Cl. G03G 15/20

(52) U.S. Cl. 399/33

(57) ABSTRACT

A fixing device thermally fixes an unfixed image formed on a recording sheet that passes through a nip, the nip being formed by a pressing member pressing against a circumferential surface of a heating rotating body that includes a resistance heating layer. The fixing device includes a power supplier configured to supply power to the resistance heating layer, a driver configured to rotate the heating rotating body, a controller configured to control supply of the power by the power supplier, and an abnormal heat detector configured to detect whether abnormal heat occurs anywhere along an entire surface of a heat-producing region within the heating rotating body, detection being performed during rotation of the heating rotating body. The controller causes the power supplier to stop supplying power to the resistance heating layer when the abnormal heat detector detects abnormal heat.

### CROSS-REFERENCE TO RELATED APPLICATIONS

This application is based on an application No. 2011-040520 filed in Japan, the contents of which are hereby incorporated by reference.

### BACKGROUND OF THE INVENTION

(1) Field of the Invention

The present invention relates to a fixing device that uses a fixing belt with a resistance heating layer and to an image forming apparatus that uses such a fixing device. In particular, the present invention relates to technology for detecting abnormal heating in the resistance heating layer.

(2) Description of the Related Art

In recent years, use of a fixing device with a fixing belt that includes a resistance heating layer has been proposed for image forming apparatuses such as printers from the perspective of reducing energy use as compared to a fixing device that produces heat via a halogen heater. For example, see Japanese Patent Application Publication No. 2009-109997.

FIG. 19A is a schematic perspective view showing the structure of a fixing device 800 based on such resistance heating. FIG. 19B is an expanded view of a section of the fixing device 800.

As shown in these figures, the fixing device 800 is provided with a fixing belt 854, a pressure roller 850, a pressing roller 860, a pair of power supply rollers 870 connected to an alternating power supply, and the like.

The fixing belt 854 is an elastically deformable cylinder that includes a resistance heating layer 854b. Electrodes 854e are formed along the outer circumference of the resistance heating layer 854b at either edge in the direction of width (the Y-axis direction).

The surface of a metal core 851 of the pressure roller 850 is covered by an elastic layer 852 that is movably placed on the inside of the running path of the fixing belt 854.

The pressing roller 860 is provided on the outside of the running path of the fixing belt 854 and presses on the pressure roller 850 via the fixing belt 854 to form a fixing nip 830.

A driving force from a drive motor (not shown in the figures) acts on the pressing roller 860, causing the pressing roller 860 to rotate in the direction of the arrow P in FIG. 19A. This driving force is transferred to the pressure roller 850 via the fixing belt 854, causing the fixing belt 854 and the pressure roller 850 to rotate in the direction of the arrow Q in FIG. 19A.

The pair of power supply rollers 870 are in contact with the electrodes 854e of the fixing belt 854 at the outside of the running path of the fixing belt 854 and are configured to push down when viewed as in FIG. 19A. Power is thus supplied to the resistance heating layer 854b of the fixing belt 854.

With the above structure, as the fixing belt 854 is rotated and power is supplied via the power supply rollers 870 to the electrodes 854e provided at either side of the resistance heating layer 854b, the electrical resistance of the electrodes 854e is far smaller than that of the resistance heating layer 854b. Therefore, as shown in FIG. 19A, a current I flows in the Y-axis direction along the entire resistance heating layer 854b, and the resistance heating layer 854b produces heat.

Note that since the current I reverses direction periodically, the direction of the current I shown in FIG. 19A is an example of the state of the current at a particular instant.

At this point, other than the portion that is being pressed by the fixing nip 830 and the power supply rollers 870, the fixing belt 854 does not come into contact with other components. Since it is difficult for heat to escape to the surrounding area, the temperature of the region occupied by the fixing nip 830 rises efficiently by Joule heating. When a recording sheet (not shown in FIG. 19A) with a toner image formed thereon passes through the fixing nip 830, the toner image heats up and is pressed to become thermally fixed to the recording sheet.

In the fixing device 800 with this structure, a scratch 854s may occur on the resistance heating layer 854b, as shown in FIG. 19A, due to improper jam clearance or introduction of a foreign object. It was discovered that the area around the scratch 854s heats up much more rapidly, exceeding the temperature limit of the fixing belt 854.

As shown in FIG. 19B, this is because the current I that flows in the Y-axis direction has to detour around the scratch 854s, thus causing a local rise in the current density at sections 891.

When such an abnormal amount of heat is produced, secondary damage may occur if current continues to flow to the resistance heating layer 854b, such as thermal deformation of the pressure roller 850 and the pressing roller 860. A structure that immediately detects an abnormal amount of heat and stops the flow of current to the resistance heating layer 854b is therefore desirable.

Even given that the temperature of the fixing belt may vary in the direction of width (the Y-axis direction), it is not normally assumed that an abnormal amount of heat will be produced at a particular spot. Heat is therefore not detected along the entirety of the resistance heating layer 854b, making it difficult to consistently detect the occurrence of an abnormal amount of heat.

### SUMMARY OF THE INVENTION

The present invention has been conceived in light of the above problem, and it is an object thereof to provide a resistance-heating based fixing device and an image forming apparatus that can, without fail, detect the occurrence of an abnormal amount of heat in the fixing device.

In order to achieve the above object, a fixing device according to a first aspect of the present invention is for thermally fixing an unfixed image formed on a recording sheet that passes through a nip, the nip being formed by a pressing member pressing against a circumferential surface of a heating rotating body that includes a resistance heating layer, the fixing device comprising: a power supplier configured to supply power to the resistance heating layer; a driver configured to rotate the heating rotating body; a controller configured to control supply of the power by the power supplier; and an abnormal heat detector configured to detect whether abnormal heat occurs anywhere along an entire surface of a heat-producing region within the heating rotating body, detection being performed during rotation of the heating rotating body, wherein the controller causes the power supplier to stop supplying power to the resistance heating layer when the abnormal heat detector detects abnormal heat.

In order to achieve the above object, an image forming apparatus according to a second aspect of the present invention is provided with a fixing device for thermally fixing an unfixed image formed on a recording sheet passing through a nip, the nip being formed by a pressing member pressing against a circumferential surface of a heating rotating body that includes a resistance heating layer, the fixing device comprising: a power supplier configured to supply power to the resistance heating layer; a driver configured to rotate the heating rotating body; a controller configured to control supply of the power by the power supplier; and an abnormal heat detector configured to detect whether abnormal heat occurs anywhere along an entire surface of a heat-producing region within the heating rotating body, detection being performed during rotation of the heating rotating body, wherein the controller causes the power supplier to stop supplying power to the resistance heating layer when the abnormal heat detector detects abnormal heat.

### BRIEF DESCRIPTION OF THE DRAWINGS

These and the other objects, advantages and features of the invention will become apparent from the following description thereof taken in conjunction with the accompanying drawings which illustrate a specific embodiment of the invention.

In the drawings:

FIG. 1 is a schematic representation of the structure of a monochrome printer, which is an example of an image forming apparatus provided with a fixing device A according to Embodiment 1 of the present invention;

FIG. 2 is a perspective view showing the structure of the fixing device A;

FIG. 3 is a cross-section diagram of the fixing device A;

FIG. 4 is a partial cross-section diagram showing the layered structure of a fixing belt in the fixing device A;

FIG. 5 is a functional block diagram showing the relationship between a controller of the image forming apparatus and the main constituent elements that are controlled by the controller;

FIG. 6 is a flowchart showing processing performed by the controller in response to abnormal heat;

FIG. 7 is an expanded view of a temperature detection region in the fixing device;

FIG. 8 is a flowchart showing processing performed by the controller to determine whether an abnormally hot section has occurred;

FIG. 9 is a perspective view showing the main structure of a fixing device B according to Embodiment 2 of the present invention;

FIG. 10 shows, for the fixing device B, the relationship between the arrangement of temperature detection traces and the intervals therebetween when the area of each temperature detection region is minimized while maintaining the shape of the temperature detection regions constant;

FIG. 11 shows the order of temperature detection along the outer circumferential surface of the fixing belt when repeating the above temperature detection operations in the fixing device B;

FIG. 12 shows the number of temperature detection paths, the shift between the starting positions of temperature detection, and whether temperature detection can be performed over all of the temperature detection paths in the fixing device B;

FIG. 13 is a flowchart showing processing performed by the controller in response to abnormal heat in the fixing device B;

FIG. 14 is a flowchart showing processing performed by the controller to determine whether an abnormally hot section has occurred in the fixing device B;

FIG. 15 shows the content of a table stored in a temperature data storage unit in an image forming apparatus according to Embodiment 2 of the present invention;

FIG. 16 is a perspective view showing the structure of a modification to the fixing device B;

FIG. 17 is a perspective view showing the structure of a modification to the fixing device B;

FIG. 18 is a perspective view showing the structure of a modification to the fixing device B; and

FIG. 19A is a perspective view of a conventional fixing device, and FIG. 19B is an enlarged view of a section thereof.

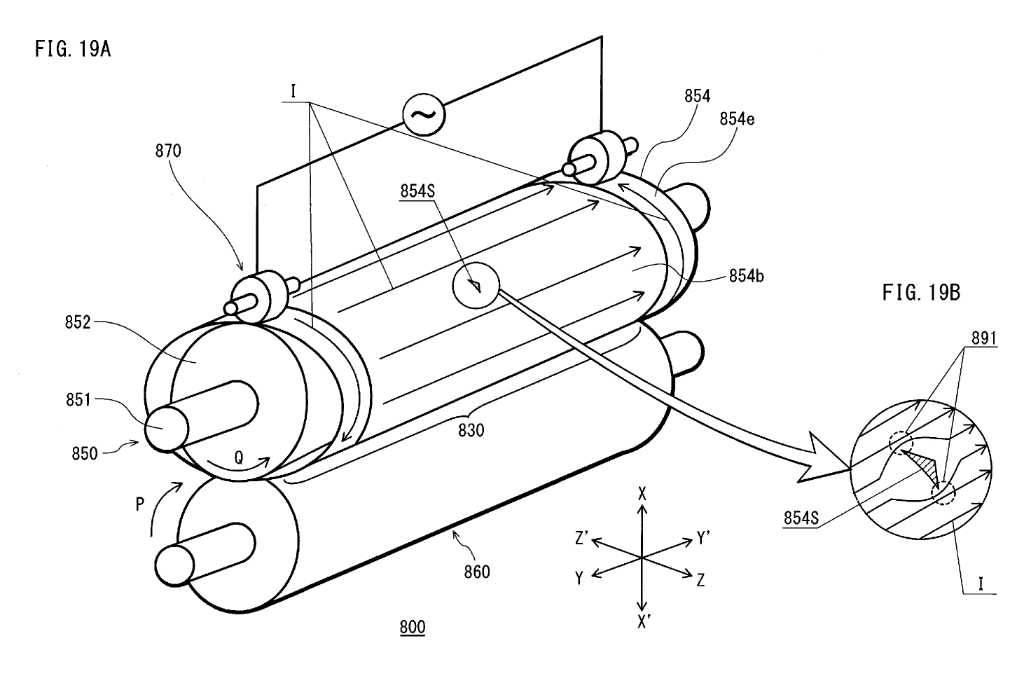

### DESCRIPTION OF THE PREFERRED EMBODIMENTS

With reference to the drawings, the following describes a fixing device and an image forming apparatus according to aspects of the present invention.

### Embodiment 1

With reference to the drawings, the following describes an image forming apparatus provided with a fixing device according to Embodiment 1 of the present invention.

### Structure of Image Forming Apparatus

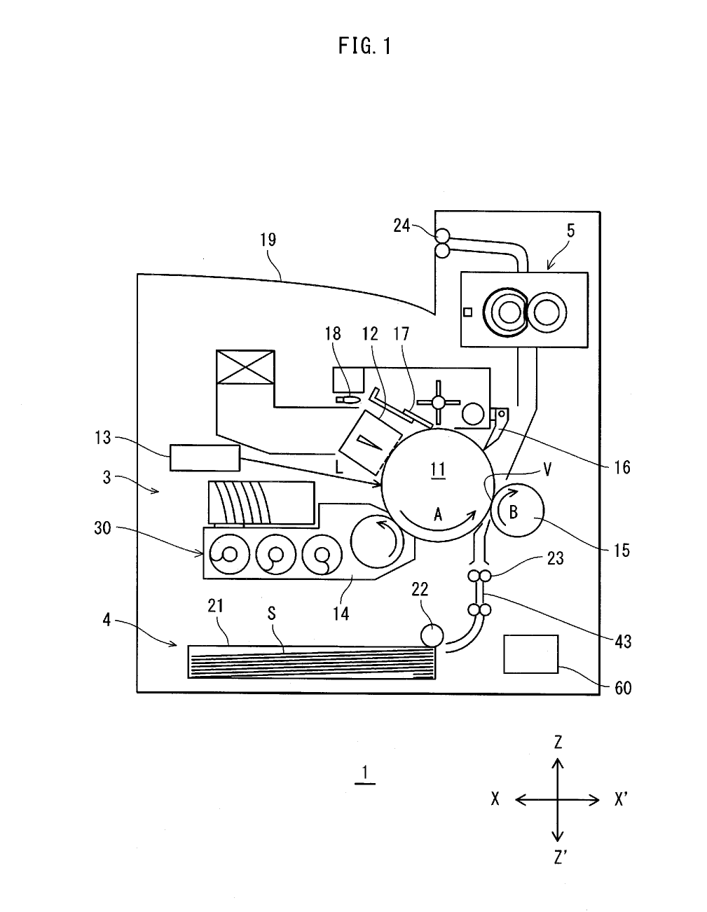

FIG. 1 is a schematic representation of the structure of a monochrome printer, which is an example of an image forming apparatus provided with a fixing device according to Embodiment 1 of the present invention.

As shown in FIG. 1, the printer 1 is provided with an image processer 3, a sheet feeder 4, a fixing unit 5, and a controller 60. The printer 1 is connected to a network (such as a LAN). Upon receiving an instruction to execute a print job from an external terminal (not shown in the figures), the printer 1 forms a monochrome toner image based on the instruction and thermally fixes the toner image in order to form a monochrome image.

The image processer 3 is provided with an image creating unit 30, an optical unit 13, and the like.

The image creating unit 30 is provided with a photoconductive drum 11, a charger 12 provided adjacent to the photoconductive drum 11, a developer 14, a transfer roller 15, a separation claw 16, a cleaner 17 that cleans the photoconductive drum 11, a discharger 18, and the like. The image creating unit 30 forms a monochrome toner image on the photoconductive drum 11, which is driven to rotate in the direction of the arrow A.

The optical unit 13 is provided with a light-emitting element such as a laser diode. In response to a drive signal from the controller 60, the optical unit 13 scans the photoconductive drum 11 by emitting laser light L for forming an image and exposing the photoconductive drum 11 to the laser light L.

Via this scanning and exposure, an electrostatic latent image forms on the photoconductive drum 11, which has been electrostatically charged by the charger 12. The developer 14 develops the electrostatic latent image to form a toner image.

The sheet feeder 4 is provided with a paper cassette 21 storing recording sheets S, a pick-up roller 22 that supplies one recording sheet S at a time from the paper cassette 21 to a conveyance path 43, a pair of timing rollers 23 that time the delivery of the supplied recording sheet S to a transfer position V, and the like. The recording sheet S is supplied from the sheet feeder 4 to the transfer position V in conjunction with movement of a toner image on the photoconductive drum 11. The toner image on the photoconductive drum 11 is transferred to the recording sheet S by the effect of the electrical field produced by transfer voltage applied to the transfer roller 15 that is driven to rotate in the direction of the arrow B.

The recording sheet S that passes through the transfer position V is separated from the surface of the photoconductive drum 11 by the separation claw 16 and then conveyed to the fixing unit 5. The toner image (unfixed image) on the recording sheet S is then fixed to the recording sheet S in the fixing unit 5 by heat and pressure and subsequently ejected into an exit tray 19 by a pair of ejection rollers 24.

### Structure of Fixing Unit

Next, the structure of the fixing unit 5 is described.

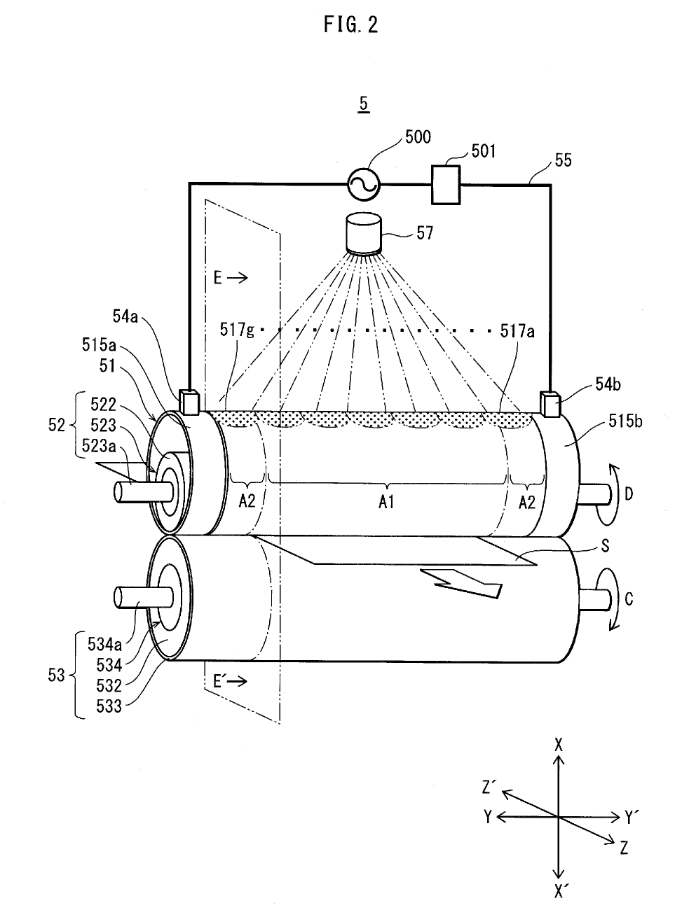

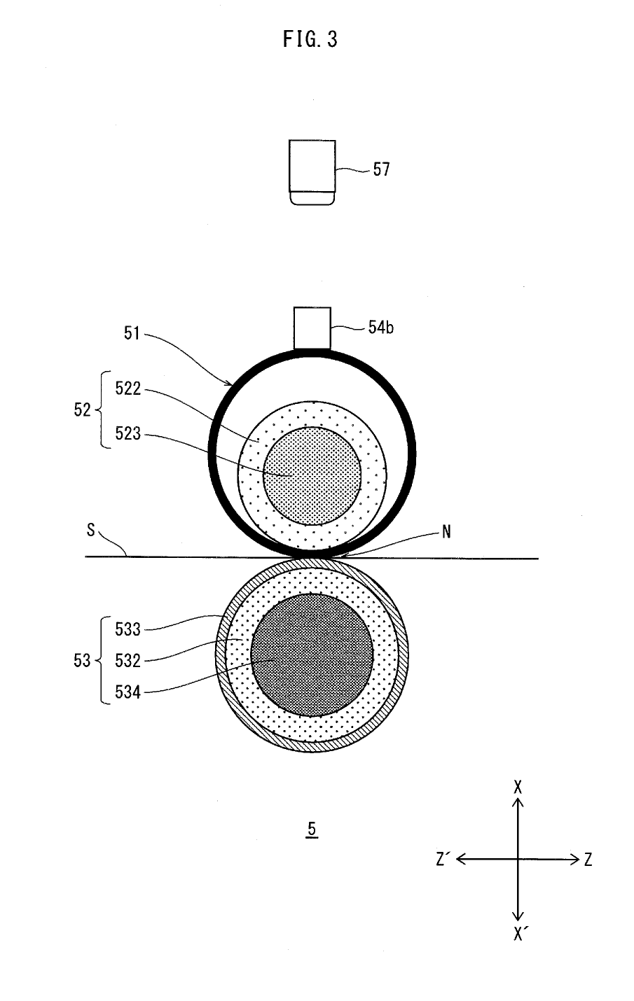

FIG. 2 is a perspective view of the fixing device 5, and FIG. 3 is a cross-section diagram of E-E′ in FIG. 2.

As shown in FIG. 2, the fixing unit 5 includes an endless, elastically deformable fixing belt 51, a pressure roller 52 that fits freely inside the fixing belt 51, a pressing roller 53 that applies pressure to the pressure roller 52 via the fixing belt 51, power feeders 54a and 54b that provide electrical power to the fixing belt 51 for heating, and a temperature sensor 57.

The fixing belt 51 may, for example, be an endless belt with an inner diameter of 30 mm. Before assembly, the fixing belt 51 is cylindrical and is made of a shape-preserving material that elastically deforms to some degree in the radial direction when an external force is applied and that returns from the deformed state, through its own restorative force, to its original shape when application of the external force ceases.

Details on the structure of the fixing belt 51 are provided below.

A metal core 523 may, for example, be an aluminum or stainless steel shaft with an outer diameter of approximately 18 mm. A small rod 523a, with a diameter smaller than the outer diameter of the metal core 523, protrudes from either edge of the metal core 523.

The elastic layer 522 is made of heat resistant rubber, such as silicone rubber or fluorine-containing rubber, or of a foam material derived from such rubber (including layers of different types of rubber). The elastic layer 522 may, for example, be 5 mm thick.

The outer diameter of the pressure roller 52 is smaller than the inner diameter of the fixing belt 51. The pressure roller 52 and the fixing belt 51 are arranged so as to touch as little as possible apart from the fixing nip N.

With this structure, the area over which heat transfers from the fixing belt 51 to the pressure roller 52 is smaller than if the fixing belt 51 and the pressure roller 52 are in close contact. This structure achieves high thermal efficiency by reducing heat transfer loss occurring when a portion of the heat emitted by the fixing belt 51 escapes through the metal core 523 of the pressure roller 52 to bearings (not shown in the figures) that rotatably support the rods 523a at either edge of the metal core 523.

Note that in Embodiment 1, out of consideration for stable revolving by the fixing belt 51, the outer diameter of the pressure roller 52 may be set, for example, to 28 mm.

For the sake of convenience, the difference between the diameters of the fixing belt 51 and the pressure roller 52 is exaggerated in the figures.

The pressing roller 53 is composed of a metal core 534 surrounded by an elastic layer 532, which is further surrounded by a releasing layer 533. The pressing roller 53 is provided on the outside of the belt running path.

The pressing roller 53 is biased by a biasing mechanism, not shown in the figures, to push the pressure roller 52 with the fixing belt 51 therebetween. The pressing roller 53 pushes from the peripheral side of the fixing belt 51, thus forming the fixing nip N (see FIG. 3) between the pressing roller 53 and the surface of the fixing belt 51.

The outer diameter of the pressing roller 53 is preferably in a range of 20 mm to 100 mm. In Embodiment 1, the outer diameter is 35 mm.

The metal core 534 may, for example, be a hollow pipe composed of aluminum or iron. The outer diameter may, for example, be 30 mm. As in the metal core 523, a small rod 534a, with a diameter smaller than the outer diameter of the metal core 534, protrudes from either edge of the metal core 534.

The thickness of the metal core 534 is preferably in range from 0.1 mm to 10 mm. In Embodiment 1, the thickness is 2 mm. Note that the metal core 534 may be a solid cylinder, or a cross-section thereof may be a different shape, such as a Y-shape with three spokes extending from the center to an outer ring.

The elastic layer 532 is made of heat resistant rubber such as silicone rubber or fluorine-containing rubber, for example, or of a foam material derived from such rubber. The thickness of the elastic layer 532 is preferably in a range of 1 mm to 20 mm. In Embodiment 1, the thickness of the elastic layer 532 is 2.5 mm.

The releasing layer 533 is made of a resin tube or a resin coating containing fluorine, such as perfluoroalkoxy (PFA). To prevent offset of toner due to electrostatic charge, a conductive material may be used.

The thickness of the releasing layer 533 is preferably in a range from 5 μm to 100 μm. In Embodiment 1, the thickness of the releasing layer 533 is 20 μm.

Note that the rods 534a at either edge in the shaft direction of the metal core 534 are rotatably supported by bearings (not shown in the figures).

The pressing roller 53 is driven to rotate in the direction of the arrow C by a driving force transferred by a driving motor (not shown in the figures).

By rotation of the pressing roller 53, the fixing belt 51 is driven to rotate in the direction of the arrow D, and the pressure roller 52 is driven to rotate in the same direction.

Note that alternatively, the pressure roller 52 may be the driving roller, with the fixing belt 51 and the pressing roller 53 being driven.

Electrodes 515a and 515b are provided along the entire outer circumference of the fixing belt 51 at either end in the direction of the rotation shaft of the pressure roller 52 (hereinafter referred to as the “roller shaft direction”) so as to sandwich the sheet conveyance region through which recording sheets are conveyed. Through a bias mechanism not shown in the figures, the pair of power feeders 54a and 54b receive a bias force from the outer periphery towards the inner periphery of the fixing belt 51 and are thus brought into contact with the electrodes 515a and 515b.

The width of the electrodes 515a and 515b in the Y-axis direction is 15 mm in this embodiment.

The power feeders 54a and 54b are, for example, rectangular parallelepiped blocks measuring 10 mm wide in the Y-axis direction, 5 mm long in the Z-axis direction, and 7 mm high in the X-axis direction. The power feeders 54a and 54b are so-called carbon brushes composed of material that is slidable and conductive, such as copper-graphite, carbon-graphite, or the like, and are electrically connected to an external power supply 500 via a conductive wire 55 and an electrical relay 501.

As described below, the fixing unit 5 is provided with a detection mechanism for detecting the occurrence of an abnormally hot section in the fixing belt 51.

Next, the structure of the fixing belt 51 is described.

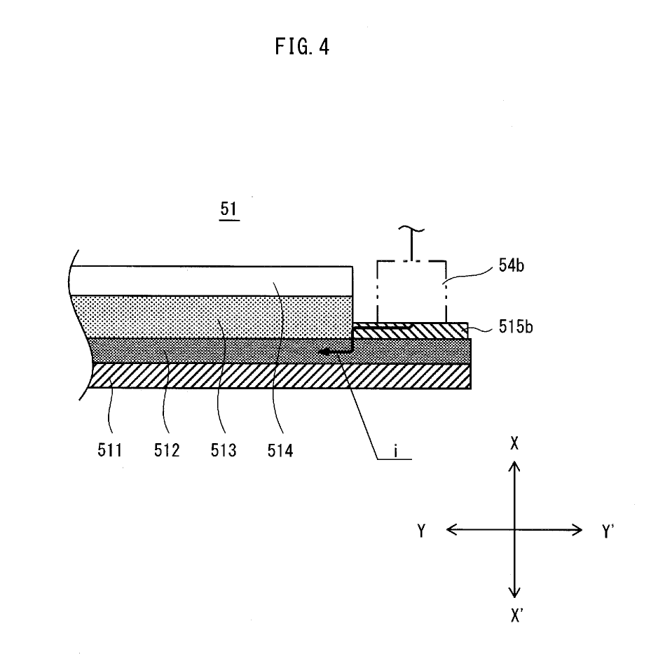

FIG. 4 is a partial cross-section diagram showing the layered structure of the fixing belt 51.

FIG. 4 focuses on one edge of the fixing belt 51 in the roller shaft direction. The other edge of the fixing belt 51 is also provided with a similar structure.

For the sake of illustration, thicknesses in FIG. 4 are slightly exaggerated. The dimensions of each component do not necessarily correspond to the example dimensions stated below.

As shown in FIG. 4, an insulating layer 511, a resistance heating layer 512, an elastic layer 513, and a releasing layer 514 are layered in this order in the fixing belt 51.

The electrodes 515a and 515b are formed on the resistance heating layer 512 at the outer periphery of the elastic layer 513 in the roller shaft direction of the pressure roller 52.

The resistance heating layer 512 receives power supplied by the electrodes 515a and 515b and produces Joule heat.

The resistance heating layer 512 is adjusted to a predetermined electrical resistivity by dispersing conductive filler in a resin material base.

The resin material that is used is preferably a heat-resistant resin such as Poly Imide (PI), Poly Phenilene Sulfide (PPS), Poly Ether Ether Ketone (PEEK), or the like.

The conductive filler that is dispersed may be a metal such as silver (Ag), copper (Cu), aluminum (Al), magnesium (Mg), or nickel (Ni), or a carbon-based material such as a carbon nanotube, carbon nanofiber, carbon microcoil, or the like. A mixture of two or more of these materials may also be used.

Assuming that the total volume of filler is maintained constant, the conductive filler is preferably fibrous in order to increase the probability of contact between individual filler particles.

The conductive filler is preferably approximately 5 μm to 100 μm thick.

The electrical resistivity of the conductive filler is of course determined by the applied voltage and current, the thickness of the resistance heating layer 512, and the diameter and length of the fixing belt 51. However, the electrical resistivity should be in a range, for example, of 1.0×10⁻⁶ Ωm to 9.9×10⁻³ Ωm, and more preferably in a range of 1.0×10⁻⁵ Ωm to 5.0×10⁻³ Ωm.

The elastic layer 513 is composed of an elastic, heat resistant material, such as silicone rubber, and has a thickness of approximately 200 μm.

Note that instead of silicone rubber, the elastic layer 513 may be composed of fluorine-containing rubber or the like.

The releasing layer 514 is preferably a structure with mold release characteristics, such as a fluorine-containing tube or a fluorine-containing coating, examples of which are Tetra Fluoro Ethylene-Perfluoro Alkylvinyl Ether Copolymer (PFA), Poly Tetra Fluoro Ethylene (PTFE), and Ethylene Tetra Fluoro Ethlylene (ETFE). The releasing layer 514 may be conductive.

The thickness of the releasing layer 514 is preferably in a range of 5 μm to 100 μm, for example.

The electrodes 515a and 515b are composed of a conductive material such as metal and are each layered all the way around the resistance heating layer 512 at the edges thereof in the roller shaft direction of the fixing belt 51.

With this structure, when electricity flows to the electrodes 515a and 515b, an even current distribution is achieved across the entire resistance heating layer 512, thus allowing for even heating.

Preferable methods for forming the above layers include plating and adhesion of metal foil using a conductive adhesive.

The material for the electrodes 515a and 515b may, for example, be a metal such as steel use stainless (SUS), aluminum (Al), nickel (Ni), brass, phosphor bronze, copper (Cu), or the like.

The insulating layer 511 is composed of a heat resistant insulating resin such as PI, PPS, PEEK, or the like, and preferably has a thickness in a range of 5 μm to 100 μm. The outer circumferential surface of the insulating layer 511 is entirely covered by the resistance heating layer 512.

With the above structure, when power is supplied to the electrodes 515a and 515b, provided at either end of the resistance heating layer 512, via the power feeders 54a and 54b while the fixing belt 51 is being driven to rotate, a current i does not flow towards the resistance heating layer 512, located directly below the electrodes 515a and 515b, in the direction of thickness thereof since the electrical resistance of the electrodes 515a and 515b is far smaller than that of the resistance heating layer 512. Rather, the current i first flows in the circumferential direction of the electrodes 515a and 515b and in the Y-axis direction towards to other electrode (hereinafter, the “electrode direction”).

Having reached the edge of the electrodes 515a and 515b in the electrode direction, the current i then flows in the direction of thickness, i.e. towards the resistance heating layer 512.

Accordingly, almost no current flows in the sections of the resistance heating layer 512 above which the electrodes 515a and 515b are layered, and these sections do not become hot.

In other words, the only region within the resistance heating layer 512 that becomes hot is a region located between the electrodes 515a and 515b (hereinafter referred to as a “hot region”).

The temperature sensor 57 is a thermopile array in which a plurality of thermopiles are arranged. As shown in FIG. 2, temperature detection regions 517a-517g corresponding to the thermopiles are aligned along the roller shaft direction without any gaps therebetween and cover the entire exposed section of the resistance heating layer 512 (see FIG. 4) in the direction of width (the Y-axis direction). The temperature sensor 57 detects the surface temperature of the rotating fixing belt 51 in each temperature detection region and transmits the detection results to the controller 60.

Note that the temperature sensor 57 is positioned at a predetermined distance from the circumferential surface of the fixing belt 51. The focal distance and angular field of view is individually adjusted for each thermopile so that the temperature detection regions 517a-517g have approximately the same area and are aligned at approximately equal intervals.

For the sake of convenience, the number of temperature detection regions is described here as being seven. The actual number may be larger.

In that case, a thermopile array with a large number of thermopiles may be used, or a plurality of thermopile arrays may be used.

Note that the total width of the temperature detection regions 517a-517g in the direction of the roller shaft is set to be at least the width of the hot region in the direction of the roller shaft.

### Structure of Controller

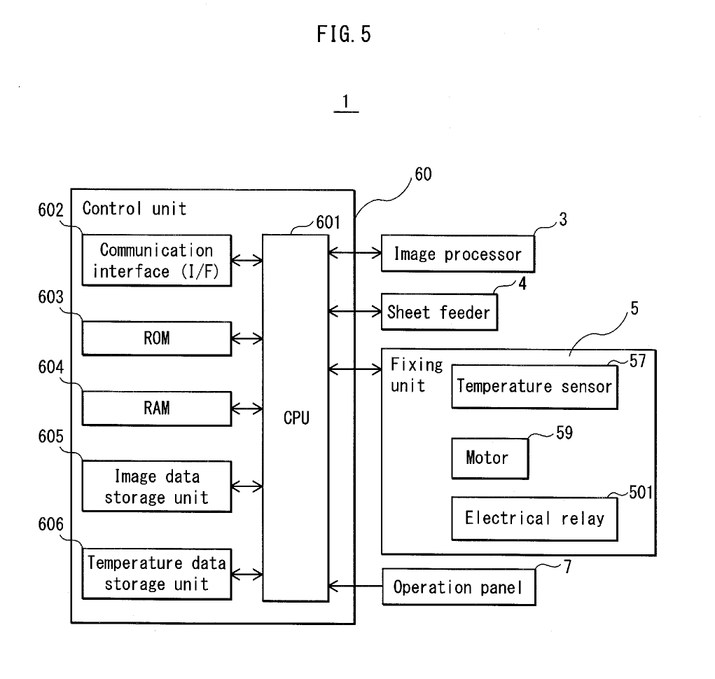

FIG. 5 is a functional block diagram showing the relationship between the structure of the controller 60 and the main constituent elements that are controlled by the controller.

The controller 60 is a so-called computer. As shown in FIG. 5, the controller 60 is provided with a Central Processing Unit (CPU) 601, a communication interface (I/F) 602, a Read Only Memory (ROM) 603, a Random Access Memory (RAM) 604, an image data storage unit 605, a temperature data storage unit 606, and the like.

The communication I/F 602 is an interface, such as a LAN card or LAN board, for connecting to a LAN.

The ROM 603 stores program for controlling the image processer 3, the sheet feeder 4, an operation panel 7, the temperature sensor 57, and the electrical relay 501. The ROM 603 also stores programs for executing processing in response to abnormal heat, as described below.

The RAM 604 is used as a work area during execution of programs by the CPU 601.

The image data storage unit 605 stores image data for printing. The image data is input via the communication I/F 602 and the like.

By executing the programs stored in the ROM 603, the CPU 601 performs control related to image formation, such as printing and image stabilization, based on a signal acquired from the operation panel 7 and the temperature sensor 57.

Furthermore, in the case of the printer 1 of Embodiment 1, the CPU 601 controls the electrical relay 501 and the like and executes the processing in response to abnormal heat, as described below.

The temperature data storage unit 606 is a nonvolatile memory such as an EEPROM storing a threshold Tk and the like used during the processing in response to abnormal heat.

This “threshold Tk” is a threshold for comparison with the difference between temperatures detected by adjacent thermopiles in the temperature sensor 57 in order to determine whether an abnormally hot section has occurred in the fixing unit 5. By way of example, the threshold Tk is set to 20° C. in Embodiment 1.

The CPU 601 switches the electrical relay 501 in the fixing unit 5 on and off.

The operation panel 7 includes a liquid crystal display, a touch panel layered on the liquid crystal display, operation buttons for inputting a variety of instructions, and the like. The operation panel 7 receives input of instructions from a user via operation of the touch panel, the operation buttons, and the like.

The liquid crystal display displays an operation screen for a print setting screen and the like, as well as a variety of information on printing results and the like.

### Processing in Response to Abnormal Heat

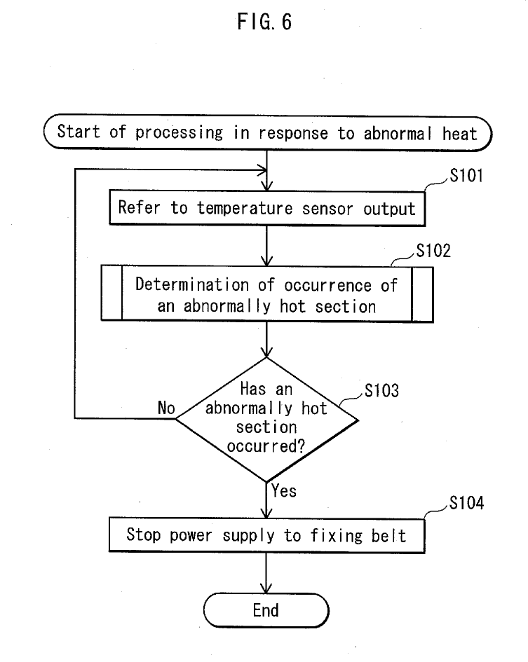

FIG. 6 is a flowchart showing processing performed by the controller 60 in response to abnormal heat.

While the CPU 601 causes the fixing belt 51 to rotate and executing temperature control of the fixing belt 51 (hereinafter referred to as the “temperature control period”), the CPU 601 refers to a signal output from the temperature sensor 57 (step S101) and performs a subroutine to determine whether an abnormally hot section has occurred in the fixing belt 51 (hereinafter referred to as the “determination of occurrence of an abnormally hot section”) (step S102).

During one signal output, the temperature sensor 57 sequentially outputs a signal from each thermopile. The time required for one signal output is extremely short.

Accordingly, by referring to the signal output of the temperature sensor 57 in step S101, the CPU 601 can acquire a signal output by each of the thermopiles.

The temperature control period is, for example, a warming up period or a printing execution period.

As long as no abnormally hot section exists, the operations in step S102 and step S101 are repeated over a predetermined period (step S103: NO). When an abnormally hot section is detected (step S103: YES), current is cut off in the electrical relay 501 to stop power supply to the fixing belt 51 (step S104), thus ending the processing in response to abnormal heat.

As this point, a message warning of the occurrence of an abnormally hot section may be displayed on the operation panel 7.

Temperature is detected in each of the temperature detection regions 517a-517g corresponding to the thermopiles in the temperature sensor 57 at approximately the same time. The period for repeating processing from step S101 to step S103 (hereinafter referred to as the “temperature detection period”) Cy1, in seconds, may be determined as follows.

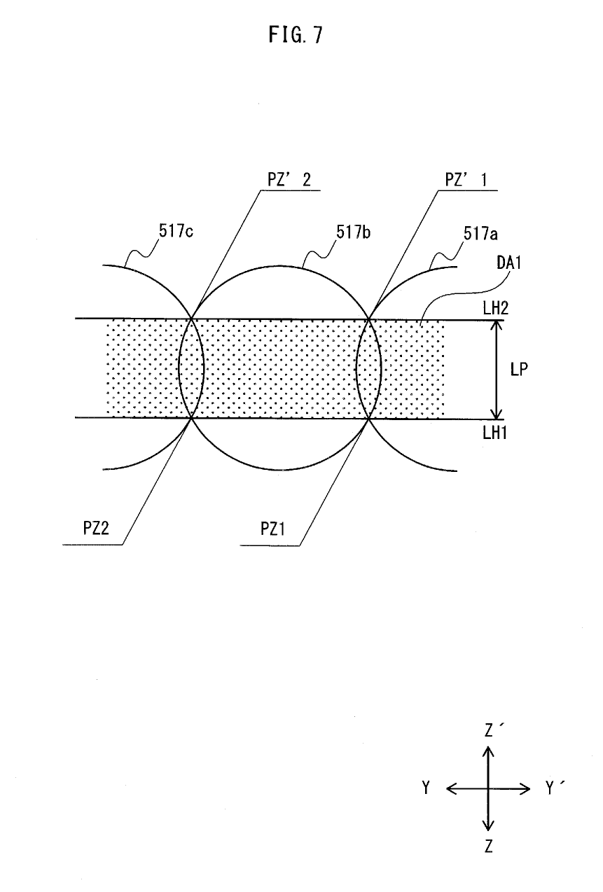

FIG. 7 is an expanded view of temperature detection regions 517a, 517b, and 517c.

As shown in FIG. 7, the outline of each temperature detection region is approximately circular. Connecting two points, PZ1 and PZ2, where adjacent outlines intersect yields a line LH1 parallel to the Y axis. Similarly connecting two intersection points PZ′1 and PZ′2, which are higher in the Z′ direction than the points PZ1 and PZ2, yields a line LH2 parallel to the Y axis.

The region enclosed between these two lines LH1 and LH2 is substantially the temperature detection region on the outer circumferential surface of the fixing belt 51 (hereinafter referred to as the “temperature detection region DA1”). The height in millimeters of this region in the Z-axis direction is referred to as LP.

Letting the running speed of the outer circumferential surface of the fixing belt 51 be V1 mm/s, the temperature detection period Cy, in seconds, satisfies Expression 1 below.

Expression 1:

Cy1≦LP/V1

By thus defining the value of the temperature detection period Cy1, the temperature can be detected over the entire outer circumferential surface of the fixing belt 51 upon one rotation of the fixing belt 51.

Next, the determination of occurrence of an abnormally hot section is described.

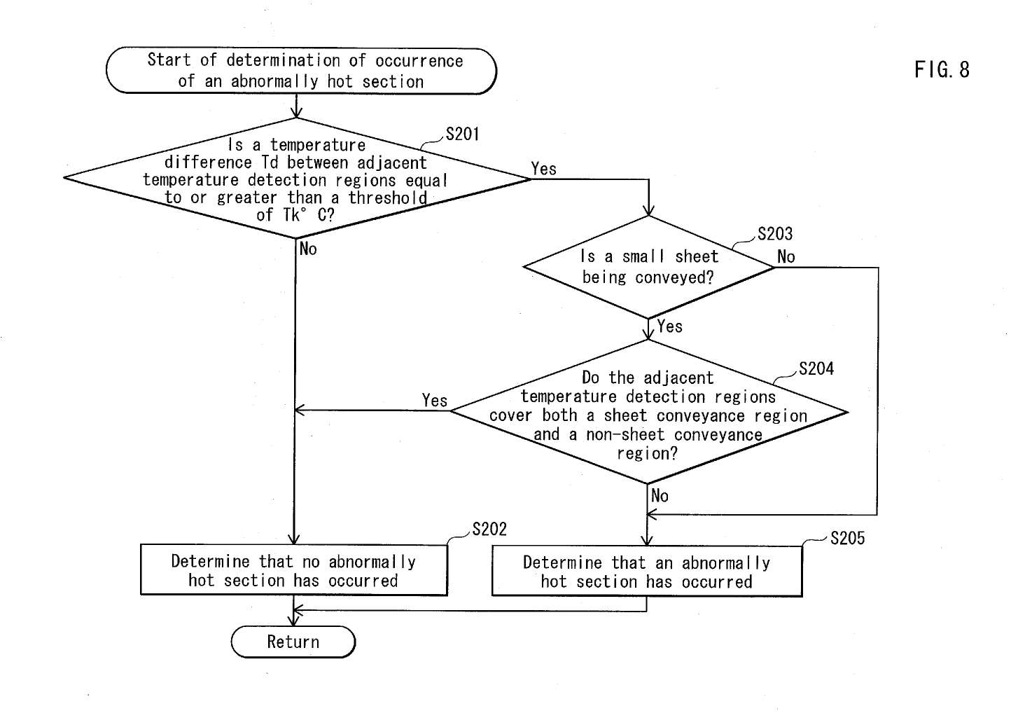

FIG. 8 is a flowchart showing processing performed by the controller 60 to determine whether an abnormally hot section has occurred.

The CPU 601 determines whether a temperature difference Td between adjacent temperature detection regions is equal to or greater than a threshold Tk. If Td is less than the threshold Tk (step S201: NO), the CPU 601 determines that an abnormally hot section has not occurred (step S202) and returns to the main routine.

Note that the value of the temperature in each temperature detection region 517a-517g is obtained by multiplying the value of the output signals from the thermopiles in the temperature sensor 57 by a predetermined conversion coefficient.

To obtain the temperature difference Td between adjacent detected regions, it suffices to calculate the difference between the temperature values of adjacent thermopiles obtained in the above way.

If the temperature difference Td is greater than or equal to the threshold Tk (step S201: YES), the CPU 601 determines whether a print job that conveys a small recording sheet S (hereinafter referred to as “small sheet conveyance”) is being performed. If no print job with small sheet conveyance is being performed (step S203: NO), the CPU 601 determines that an abnormally hot section has occurred (step S205) and returns to the main routine.

The determination of whether a print job with small sheet conveyance is being performed is made based on a paper size selection received from the operation panel 7, or on paper size information included in a print execution command obtained via the communication I/F 602.

Conversely, if a print job with small sheet conveyance is being performed (step S203: YES), the CPU 601 determines whether the above adjacent detection regions are near the border between the sheet conveyance region and non-sheet conveyance region (step S204). In other words, the CPU 601 determines whether the temperature detection regions corresponding to the two temperatures that yielded the temperature difference Td cover both the sheet conveyance region A1 and the non-sheet conveyance region A2 shown in FIG. 2.

If the temperature detection regions corresponding to the two temperatures that yielded the temperature difference Td cover both the sheet conveyance region A1 and the non-sheet conveyance region A2, as do the temperature detection regions 517a and 517b in FIG. 2, for example (step S204: YES), then the CPU 601 determines that an abnormally hot section has not occurred (step S202). The CPU 601 makes this determination in order to prevent erroneous detection, since a difference in heat discharge occurring in these regions is due to conveyance of a sheet, which causes the temperature difference Td to easily increase. Processing then returns to the main routine.

If the temperature detection regions corresponding to the two temperatures that yielded the temperature difference Td do not cover both the sheet conveyance region A1 and the non-sheet conveyance region A2 (step S204: NO), then the CPU 601 determines that an abnormally hot section has occurred (step S205) since a temperature difference Td that is equal to or greater than the threshold Tk is thought to be caused by an abnormally hot section. Processing then returns to the main routine.

During the determination in step S204, in order for the CPU 601 to determine whether each detection region is included in the sheet conveyance region A1 or the non-sheet conveyance region A2, a table indicating whether each detection region corresponds to the sheet conveyance region A1 or the non-sheet conveyance region A2 for different sizes of recording sheets S, for example, may be stored in advance in the ROM 603.

Determining the occurrence of an abnormally hot section in this way based on the temperature difference Td between adjacent temperature detection regions allows for accurate detection of the occurrence of an abnormally hot section, since if a ripple occurs during temperature control, causing the overall temperature of the fixing belt 51 to depart from the target temperature, the temperature difference Td between adjacent temperature detection regions is not easily affected by the ripple.

Furthermore, the temperature detection period Cy1, the width LP of the temperature detection region DA1, and the running speed V1 of the outer circumferential surface of the fixing belt 51 are set so that temperature is detected over the entire outer circumferential surface of the fixing belt 51. Therefore, any abnormally hot section occurring in the fixing device is detected without fail.

### Embodiment 2

The structure of a fixing unit 5a according to Embodiment 2 is basically the same as the fixing unit 5 according to Embodiment 1. The structure of the temperature sensor 57, the processing in response to abnormal heat, and the determination of occurrence of an abnormally hot section differ from the fixing device in Embodiment 1.

The following explanation focuses on the differences between Embodiment 1 and Embodiment 2, using the same reference signs for constituent elements that are shared in common with Embodiment 1 and omitting or simplifying the explanation thereof.

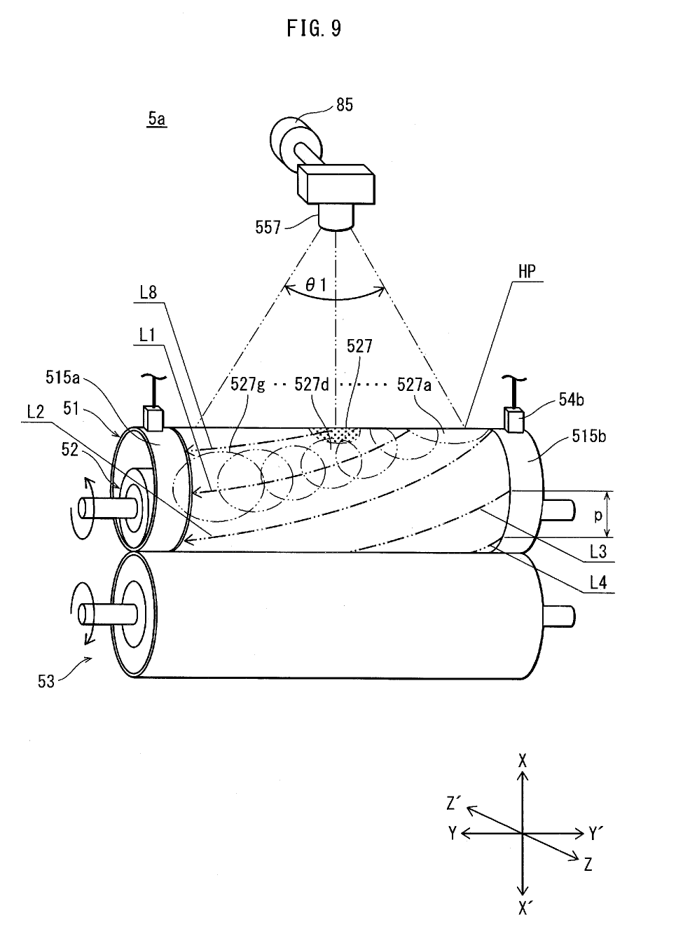

FIG. 9 is a perspective view showing the main structure of the fixing unit 5a according to Embodiment 2.

As shown in FIG. 9, the fixing unit 5a in Embodiment 2 is provided with a temperature sensor 557 instead of the temperature sensor 57 in Embodiment 1 and a stepping motor 85 that changes the detection direction of the temperature sensor 557 in the XY plane.

The temperature sensor 557 is composed of one thermopile that detects temperature in a roughly circular temperature detection region 527.

In Embodiment 2, the CPU 601 repeatedly detects the temperature while causing the fixing belt 51 to rotate and swaying the temperature sensor 557 in the Y-axis direction to displace the position of the temperature detection region 527, thereby detecting the temperature over the entire outer circumferential surface of the fixing belt 51 within a predetermined amount of time.

When operations for temperature detection are executed in this way, the center of the temperature detection region 527 traces paths along the outer circumferential surface of the fixing belt 51, such as the spiral paths L1, L2, . . . , L8 in FIG. 9.

The area of each trace of the temperature detection region 527 when temperature is detected along the path L1, i.e. the area of the temperature detection traces 527a-527g in FIG. 9, is not constant. Rather, using the normal direction of the outer circumferential surface of the fixing belt 51 as a reference, the area of each trace grows larger as a sway angle θ1 of the temperature sensor 557 increases, due to increased distance between the temperature sensor 557 and the temperature detection position.

For the sake of convenience, the number of temperature detection traces is described here as being seven. The actual number may be larger.

Furthermore, the temperature sensor 557 in Embodiment 2 only detects temperature while the temperature detection region 527 is being displaced in the Y direction. While the temperature detection region 527 is being displaced in the Y′ direction, temperature detection is suspended.

In order to detect temperature over the entire outer circumferential surface of the fixing belt 51, an interval p in the Z-axis direction between the path L1 and the adjacent path L2 needs to be set to an appropriate value.

The following describes the method for deriving the interval p.

First, among the temperature detection traces 527a-527g, let the trace with the smallest area be the temperature detection trace 527d.

If the interval p is set so that temperature can be detected over the entire outer circumferential surface of the fixing belt 51 with the temperature detection trace 527d that has the smallest area, then temperature detection can be performed without any gaps, since the other temperature detection traces have a larger area than the temperature detection trace 527d.

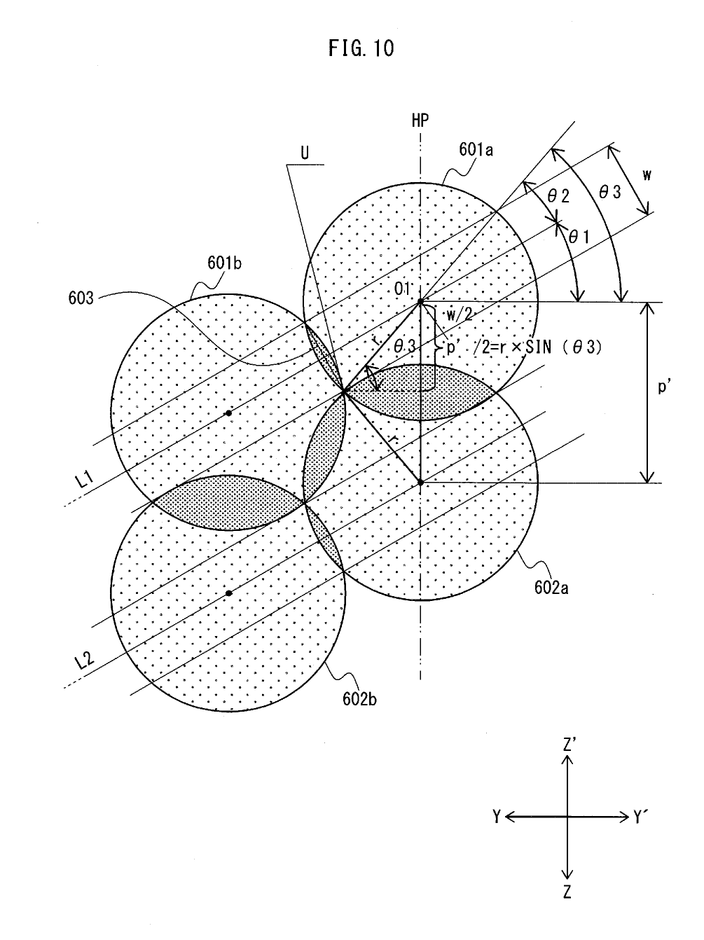

FIG. 10 shows the relationship between the arrangement of temperature detection traces 601a, 601b, . . . along the outer circumferential surface of the fixing belt 51 and the interval p between the temperature detection traces assuming that the temperature detection region 527 is the same as the temperature detection trace 527d with the smallest area, i.e. a circle with radius r, and that the area does not change as the temperature detection position varies.

Note that for the sake of convenience, FIG. 10 shows the arrangement of temperature detection traces 601a, 601b, . . . when depicting the fixing belt 51 in a planar state.

First, focusing on the position of each temperature detection trace on the path L1, in order to detect temperature over the entire outer circumferential surface of the fixing belt 51, it is necessary for adjacent temperature detection traces 601a and 601b to overlap (the overlapping section being referred to as an “overlapping section 603”).

The length of the overlapping section 603 in a direction perpendicular to the path L1 and an overlap width W are defined below.

If the overlapping section 603 and the temperature detection trace 602a along the path L2 do not overlap, and if the respective outlines do not touch, then a space that is not covered by a temperature detection trace appears below the point U in FIG. 10. In other words, the temperature cannot be detected over the entire outer circumferential surface of the fixing belt 51.

In FIG. 10, the respective outlines of the overlapping section 603 and the temperature detection trace 602a are in contact.

In this state, the interval p′ in the Z-axis direction between the path L1 and the path L2 is sought. Setting the actual interval p between the path L1 and the path L2 to be smaller than this interval p′ allows for temperature detection over the entire outer circumferential surface of the fixing belt 51.

As shown in FIG. 10, the length of a straight line connecting the point U with the center O1 of the temperature detection trace 601a is equivalent to the radius r of the temperature detection trace 601a. Letting the angle formed by this straight line and the Y axis be θ3, the interval p′ can be sought from the angle θ3 and the radius r by Expression 2 below.

Expression 2:

p′=2r×SINθ3

The angle θ3 satisfies the relationship in Expression 3 below.

Expression 3:

θ3=θ1+θ2

The angles θ1 and θ2 are sought as follows.

Expression 4:

θ2=SIN⁻¹(W/2r)

Expression 5:

θ1=TAN⁻¹(V3/V2)

V2: Speed of displacement in mm/s in the Y direction of the temperature detection region 527

V3: running speed in mm/s of the outer circumferential surface of the fixing belt 51

The value of V2 is determined by the step angle of the stepping motor 85, the response speed of each pulse, the number of steps in one scan, and the like.

The value of V3 is set in accordance with the system speed.

Using these expressions, if the radius r is 8.5 mm, the interval p′ is for example calculated as 12 mm.

Since the inner diameter of the fixing belt 51 is 30 mm and the thickness is 0.5 mm, then letting the outer diameter be 31 mm, the total number of paths is eight, obtained by dividing the outer circumference of the fixing belt 51 by p′ and rounding the result, 7.9, up to an integer value.

Accordingly, by displacing the temperature detection region 527 along the paths L1-L8 at the speed V2, the temperature can be detected over the entire outer circumferential surface of the fixing belt 51.

Displacement of the temperature detection region 527 is achieved by swaying of the temperature sensor 557. Since the range of sway is wide, however, the time required for one sway (hereinafter “sway period”) is necessarily longer than the time for one rotation of the fixing belt 51 (hereinafter “rotation period”).

For example, if the rotation period is 0.44 s, even the shortest sway period is 1.0 s, which is over twice the value of the rotation period.

As a result, the temperature cannot be detected sequentially across adjacent paths, i.e. in the order L1, L2, . . . , L8.

With the above conditions on period, the temperature detection region 527 returns to the home position HP after 2.26 rotations of the fixing belt 51 after the start of temperature detection along path L1 (see FIG. 9).

Through calculation, it was confirmed that at this stage, the point located at the home position HP is a point along a line connecting the edge of the path L5 in the Y′ direction and the edge of the path L4 in the Y′ direction.

Note that the response time of the stepping motor here is 7 ms/pulse, whereas the response time of the temperature sensor 557 is approximately 5 ms. By synchronizing the timing of temperature sampling by the temperature sensor 57 with the pulse output to the stepping motor when swaying the temperature sensor 557 during temperature detection, it is possible to detect the temperature at a target position.

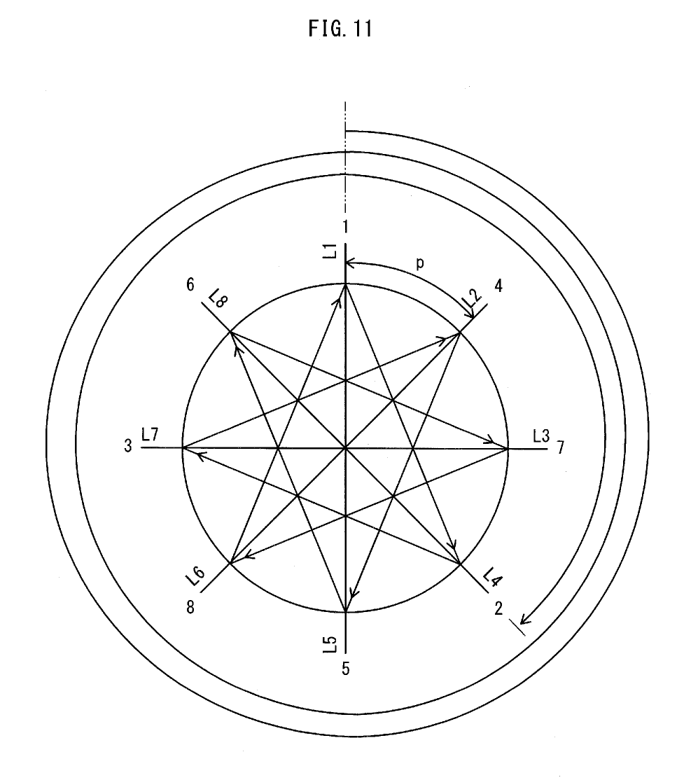

FIG. 11 shows the order of temperature detection along the outer circumferential surface of the fixing belt 51 when repeating the above temperature detection operations.

From the start of temperature detection along the path L1 until the start of temperature detection along the path L4, the fixing belt 51 actually rotates two and three-eighths times. Focusing only on the starting positions of temperature detection, however, the current starting position of temperature detection is only displaced three-eighths of a rotation from the previous starting position of temperature detection.

Since temperature detection of the fixing belt 51 is periodically repeated, this shift in the starting position of temperature detection is repeated.

As a result, temperature detection of the fixing belt 51 is performed in the order of path L1, path L4, path L7, path L2, path L5, path L8, path L3, path L6, and path L1, as shown in FIG. 11. The temperature is thus detected over the entire outer circumferential surface of the fixing belt 51.

Note that depending on the number of temperature detection paths that are set and the shift between the starting positions of temperature detection, it may not be possible to perform temperature detection over all of the paths.

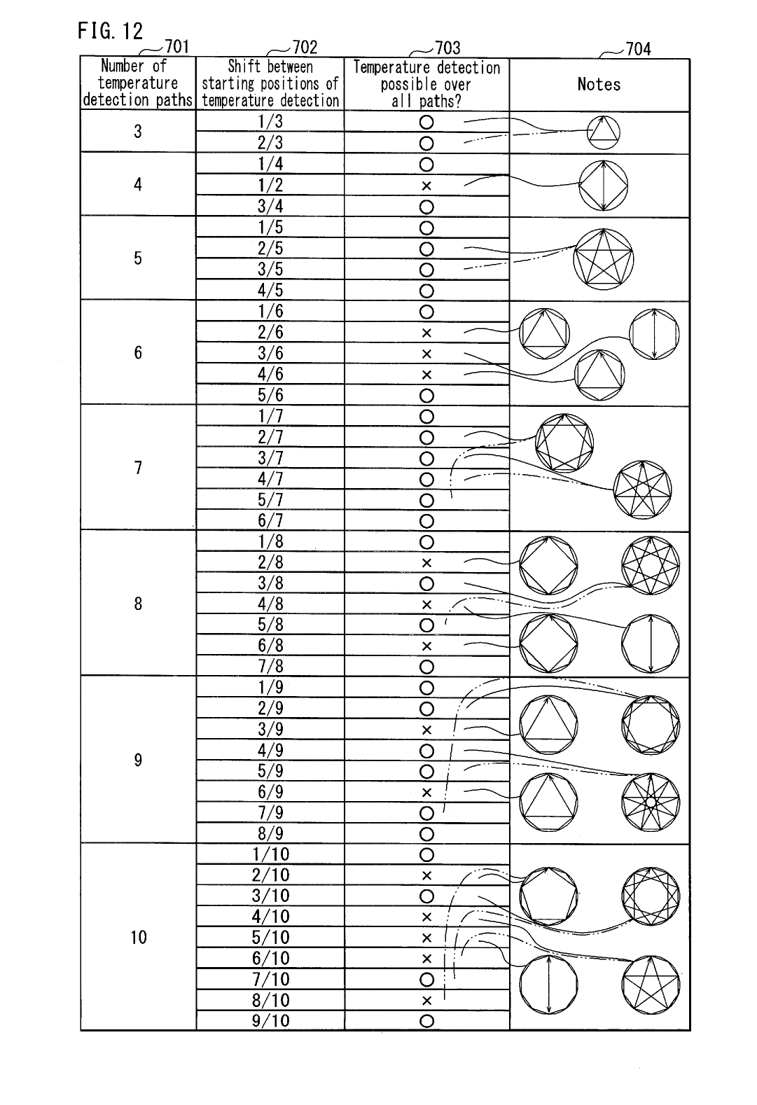

FIG. 12 shows whether temperature detection can be performed over all of the temperature detection paths when the number of paths varies from three to ten and the shift (in periods) between the starting positions of temperature detection is set to a variety of possible amounts.

Column 701 shows the number of temperature detection paths. Column 702 shows the shift (in periods) between the starting positions of temperature detection.

Column 703 shows whether temperature detection can be performed over all of the paths. A circle indicates that temperature detection can be performed over all of the paths, whereas an X indicates that temperature detection cannot be performed over all of the paths.

As shown in FIG. 12, when the number of temperature detection paths is three, five, and seven, temperature detection can be performed over all of the paths regardless of the shift between the starting positions of temperature detection.

On the other hand, in all other cases, it may or may not be possible to perform temperature detection over all of the paths depending on the shift between the starting positions of temperature detection.

The notes column 704 shows the changes in the starting position of temperature detection when temperature detection operations are repeated. The straight lines and lines with alternate long and two short dashes indicate the correspondence between the changes in the starting position of temperature detection and the shift between the starting positions of temperature detection. Note that simple changes in the starting position are omitted from FIG. 12.

The lines with alternate long and two short dashes indicate that the actual changes in the starting positions of temperature detection are bilaterally symmetric with the changes shown in FIG. 12.

If the number of temperature detection paths is set too low, then no solution can be found for the interval p, in the Z-axis direction between the path L1 and the adjacent path L2, that is necessary for performing temperature detection over the entire outer circumferential surface of the fixing belt 51. On the other hand, if the number of temperature detection paths is too high, the time until temperature detection is complete over the entire outer circumferential surface of the fixing belt 51 grows long. It is therefore necessary to set an appropriate number of temperature detection paths taking into consideration factors such as the system speed and the dimensions of the constituent elements of the fixing unit 5.

The following describes processing in response to abnormal heat.

### Processing in Response to Abnormal Heat

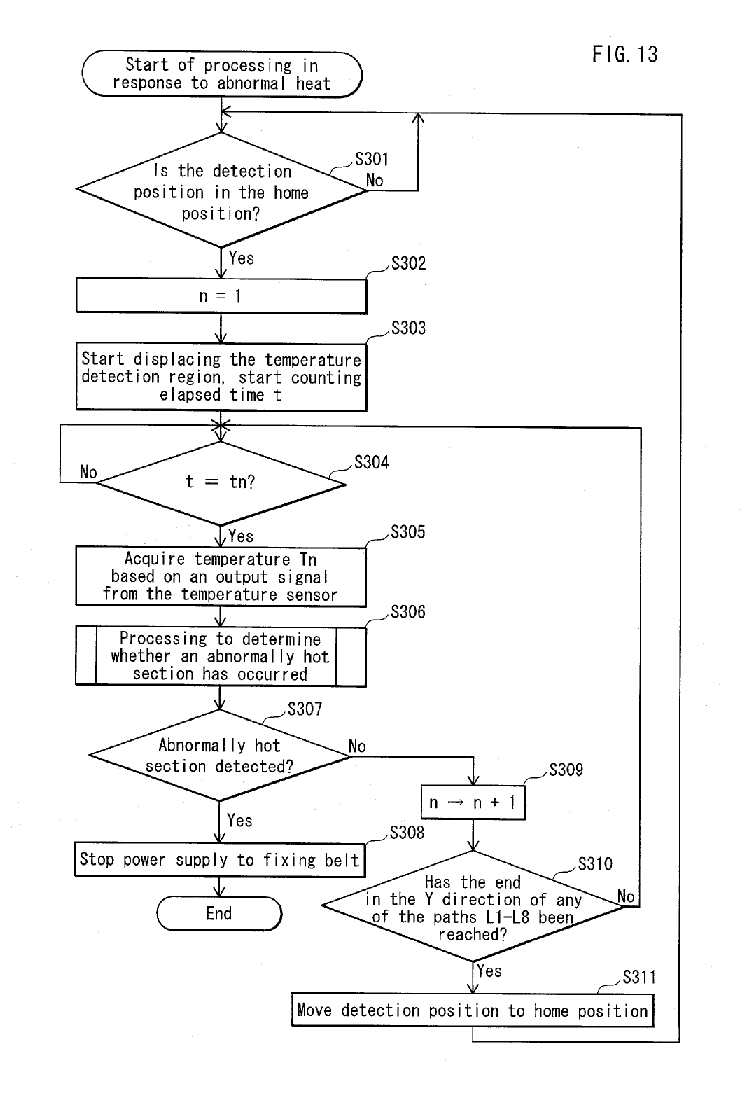

FIG. 13 is a flowchart showing processing performed by the controller 60 in response to abnormal heat.

While causing the fixing belt 51 to rotate and executing temperature control of the fixing belt 51, i.e. during the temperature control period, the CPU 601 determines whether the temperature detection region 527 has returned to the home position HP. If not, the CPU 601 waits until the temperature detection region 527 returns to the home position HP (step S301: NO).

The CPU 601 determines whether the temperature detection region 527 has returned to the home position HP by storing, in the temperature data storage unit 606, a history of pulse outputs to the stepping motor 85 by referring to this history.

If the temperature detection region 527 has returned to the home position HP (step S301: YES), the CPU 601 sets a variable n to an initial value of 1 (step S302), starts displacing the temperature detection region 527, and starts counting elapsed time t (step S303).

The CPU 601 then determines whether the elapsed time t has reached tn (step S304).

The value of tn corresponds to the variable n and indicates the point in time at which temperature detection is to be performed, i.e. the timing of temperature detection.

In the printer 1 in Embodiment 2, the times t1, t2, . . . , tn are stored as a table in the temperature data storage unit 606 along with a threshold Tx and temperature conversion coefficients h1, . . . , hn, as described below.

If the elapsed time t has not reached tn, the CPU 601 waits until t=tn (step S304: NO).

On the other hand, if the elapsed time t has reached tn, the CPU 601 acquires the temperature Tn based on an output signal from the temperature sensor (step S305) and performs a subroutine to determine whether an abnormally hot section has occurred in the fixing belt 51 (step S306).

When an abnormally hot section is detected (step S307: YES), current is cut off in the electrical relay 501 to stop power supply to the fixing belt 51 (step S308), thus ending the processing in response to abnormal heat.

As this point, as in Embodiment 1, a message warning of the occurrence of an abnormally hot section may be displayed on the operation panel 7.

Conversely, if no abnormally hot section is detected (step S307: NO), the value of the variable n is incremented by one (step S309). The CPU 601 determines whether the temperature detection position has reached the end in the Y direction of any of the paths L1, . . . , L8. If so, the CPU 601 displaces the temperature detection position to the home position HP (step S310: YES). If the temperature detection position has not reached the end (step S310: NO), the CPU 610 performs the steps starting with step S304, in which the CPU 610 determines whether the elapsed time t has reached tn.

Next, the determination of occurrence of an abnormally hot section is described.

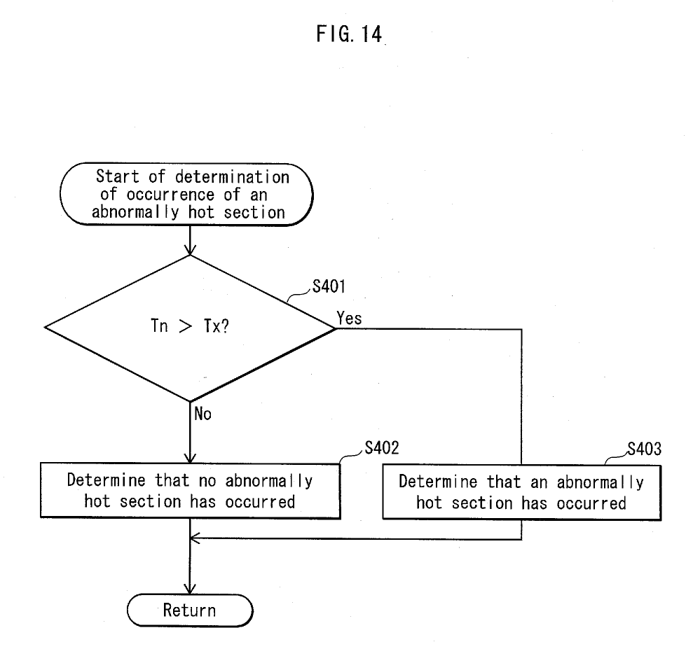

FIG. 14 is a flowchart showing processing performed by the controller 60 to determine whether an abnormally hot section has occurred.

The CPU 601 determines whether the value of the detected temperature Tn exceeds the threshold Tx (step S401).

The temperature Tn is not calculated only based on the signal output by the temperature sensor 557. Rather, the temperature Tn is calculated as follows.

The area of the temperature detection region 527, i.e. the area of each of the temperature detection traces 527a-527g is not constant. Rather, the area increases closer towards either edge of the fixing belt 51 in the Y-axis direction. Therefore, even if the temperature along the entire outer circumferential surface of the fixing belt 51 is maintained constant, the value of the detected temperature increases, since the amount of infrared radiation that enters the photoreceptive surface of the temperature sensor 557 increases closer towards the edges of the fixing belt 51.

To correct for this sort of error, the proper temperature Tn needs to be calculated by multiplying the output signal value obtained from the temperature sensor 557 by a temperature conversion coefficient corresponding to the surface area of the detection position.

The temperature data storage unit 606 stores a table 710 for calculating the temperature Tn by taking such temperature correction into consideration.

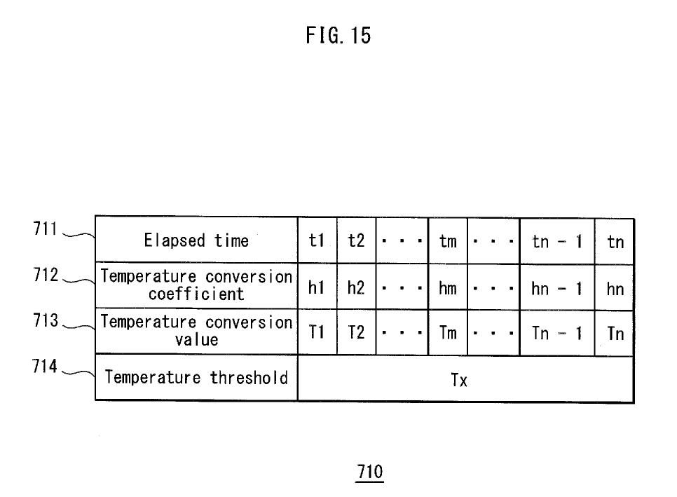

FIG. 15 shows this table 710.

In FIG. 15, column 711 lists elapsed times t1-tn. Column 712 lists temperature conversion coefficients h1-hn. Column 713 lists temperature conversion values T1-Tn. Finally, column 714 shows the threshold Tx.

The elapsed times t1, t2, . . . , tn correspond to temperature detection positions. Each of the elapsed times t1, t2, . . . , tn is associated with a respective temperature conversion coefficient h1, h2, . . . , hn.

For example, the detection position after elapsed time t1 corresponds to the temperature detection trace 527a, the detection position after elapsed time tn corresponds to the temperature detection trace 527g, and the detection position after elapsed time tm, which occurs between elapsed times t1 and tn, corresponds to the temperature detection trace 527d. The value of the temperature conversion coefficient hm is set to the largest value, and using the temperature conversion coefficient hm as a reference, the temperature conversion coefficient is set to gradually smaller values as the temperature conversion coefficient approaches either the temperature conversion coefficient h1 or the temperature conversion coefficient hn.

The threshold Tx is a temperature at which abnormal heat is considered to have occurred. In Embodiment 2, Tx is set to 350° C.

To prevent erroneous detection of occurrence of an abnormally hot section during small sheet conveyance, this threshold Tx is set higher than the presumed heating temperature in the non-sheet conveyance region of the fixing belt 51 during small sheet conveyance.

Furthermore, the table 710 also stores proper temperatures T1, . . . , Tn obtained by multiplying each output signal value obtained from the temperature sensor 557 by the corresponding temperature conversion coefficient.

In order to reduce the storage capacity of the temperature data storage unit 606, it is preferable to clear the values of these temperatures T1, . . . , Tn from the table 710 when step S310 is performed to determine whether the temperature detection position has reached the end in the Y direction of any of the paths L1, . . . , L8.

If the value of Tn thus obtained is equal to or less than Tx (step S401: NO), the CPU 601 determines that an abnormally hot section has not occurred (step S402), and processing returns to the main routine.

If the value of Tn is larger than Tx (step S401: YES), the CPU 601 determines that an abnormally hot section has occurred (step S403), and processing returns to the main routine.

As described above, even if the area of the temperature detection region 527 changes, the temperature of the outer circumferential surface of the fixing belt 51 can be accurately detected by multiplying the output signal value from the temperature sensor 57 by the value of the temperature conversion coefficient hn corresponding to the area.

Furthermore, the displacement speed V2 in the Y direction of the temperature detection region 527, the running speed V3 of the outer circumferential surface of the fixing belt 51, the radius r of the temperature detection region, the overlap width W, and the interval p of the temperature detection path are set so that temperature is detected over the entire outer circumferential surface of the fixing belt 51. Therefore, any abnormally hot section occurring in the fixing device is detected without fail.

### <Modifications>

While the present invention has been described based on Embodiments 1 and 2, the present invention is of course not limited to Embodiments 1 and 2. The following modifications are possible.

(1) In Embodiment 2, in order to change the direction of temperature detection by the temperature sensor 557, the temperature sensor 557 is swayed directly, but the temperature sensor 557 is not limited to this structure.

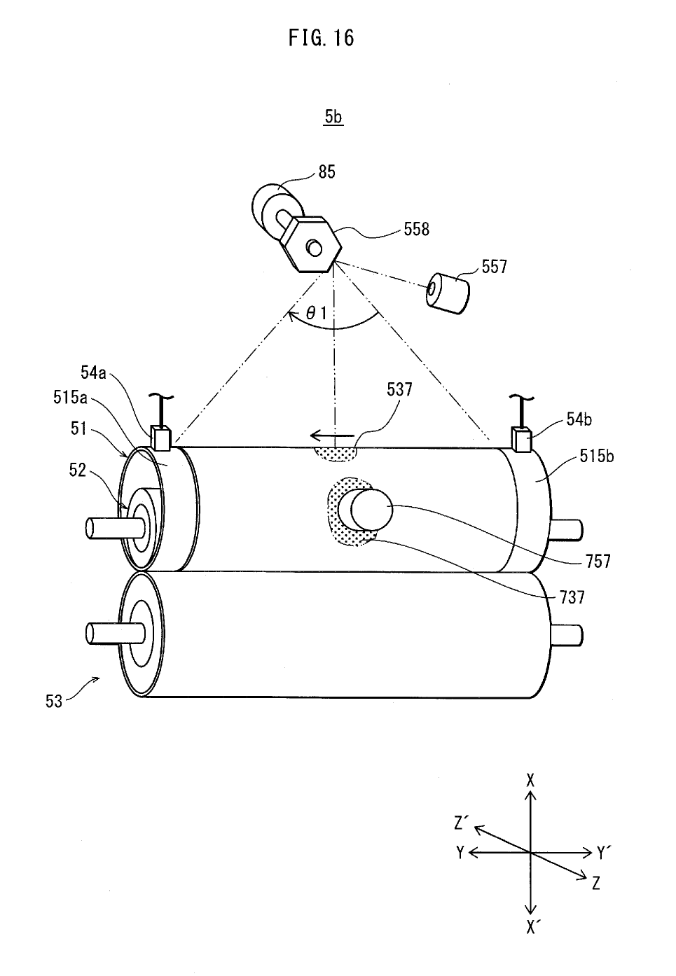

FIG. 16 is a perspective view showing the structure of a fixing unit 5b that changes the direction of temperature detection by the temperature sensor 557 via a different method than Embodiment 2.

The fixing unit 5b is basically the same as the fixing unit 5a according to Embodiment 2, differing in that the temperature sensor 57 and the stepping motor 85 are not directly connected.

Specifically, as shown in FIG. 16, a polygon mirror 558 in the fixing unit 5b is attached to the rotation axis of the stepping motor 85, and the temperature sensor 557 is fixed to the body (not shown in the figure) of the printer 1 so that the photoreceptive surface of the temperature sensor 557 faces the reflective surface of the polygon mirror 558.

With this structure, if the stepping motor 85 is for example rotated in the clockwise direction within FIG. 16 over a constant period, the temperature can be detected while moving the temperature detection region 537 in the Y direction along the outer circumferential surface of the fixing belt 51.

Note that since the temperature sensor 557 is fixed in the present structure, no vibrations occur, thus improving accuracy of temperature detection.

(2) In Embodiment 1, the temperature difference Td between adjacent temperature detection regions is compared with the threshold Tk, and in Embodiment 2, the temperatures T1, T2, . . . , Tn in the temperature detection regions are compared with the threshold Tx in order to determine whether an abnormally hot section has occurred, but determination is not limited in this way.

For example, if a temperature sensor 757 for controlling the temperature of the fixing belt 51 is provided in the fixing unit 5b, as shown in FIG. 16, an abnormally hot section may be determined to have occurred when the difference between the temperature detected by the temperature sensor 757 (referred to as the “reference temperature”) and the temperatures detected while displacing the temperature detection region 537 exceeds a predetermined value.

Of course, in this case, erroneous detection due to a temperature rise in the non-sheet conveyance region of the fixing belt 51 during small sheet conveyance may be avoided by appropriately setting the predetermined value.

(3) In order to change the position of the temperature detection region, in Embodiment 2, the temperature sensor 557 is directly swayed, and in Modification (1), the polygon mirror 558 is provided between the temperature sensor 557 and the target of temperature detection, but the present invention is not limited to these structures.

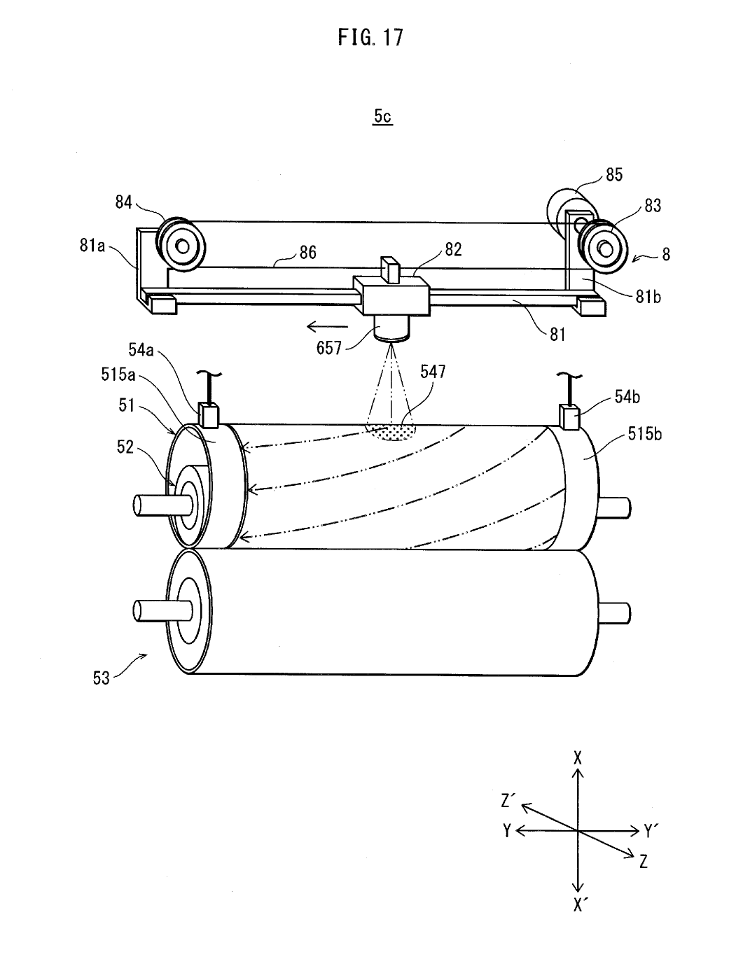

FIG. 17 is a perspective view showing the structure of a fixing unit 5c in which the position of the temperature detection region is displaced by a different mechanism.

The fixing unit 5b is basically the same as the fixing unit 5a according to Embodiment 2, differing in that a temperature sensor 657 includes a mechanism 8 (hereinafter referred to as a “slide mechanism”) for sliding back and forth in the Y-axis direction.

The following describes the slide mechanism 8.

In the slide mechanism 8, a rail 81 extending in the Y-axis direction is supported at either end by respective arms 81a and 81b. An idler pulley 84 is axially supported by the arm 81a, and a stepping motor 85 is provided on the arm 81b.

Furthermore, a drive pulley 83 is connected to the rotation shaft of the stepping motor 85, and the temperature sensor 657 is provided so as to slide freely along the rail 81. Edges of a wire 86 that is wound around the idler pulley 84 and the drive pulley 83 are connected to the temperature sensor 657.

With this structure, temperature can be detected by displacing the position of the temperature detection region 547 in the Y-axis direction while maintaining the area of the temperature detection region 547 constant.

(4) The temperature sensor 557 in Embodiment 2 only detects temperature while the temperature detection region 527 is being displaced in the Y direction, and while the temperature detection region 527 is being displaced in the Y′ direction, temperature detection is suspended. The temperature may also be detected, however, while the temperature detection region 527 is being displaced in the Y′ direction.

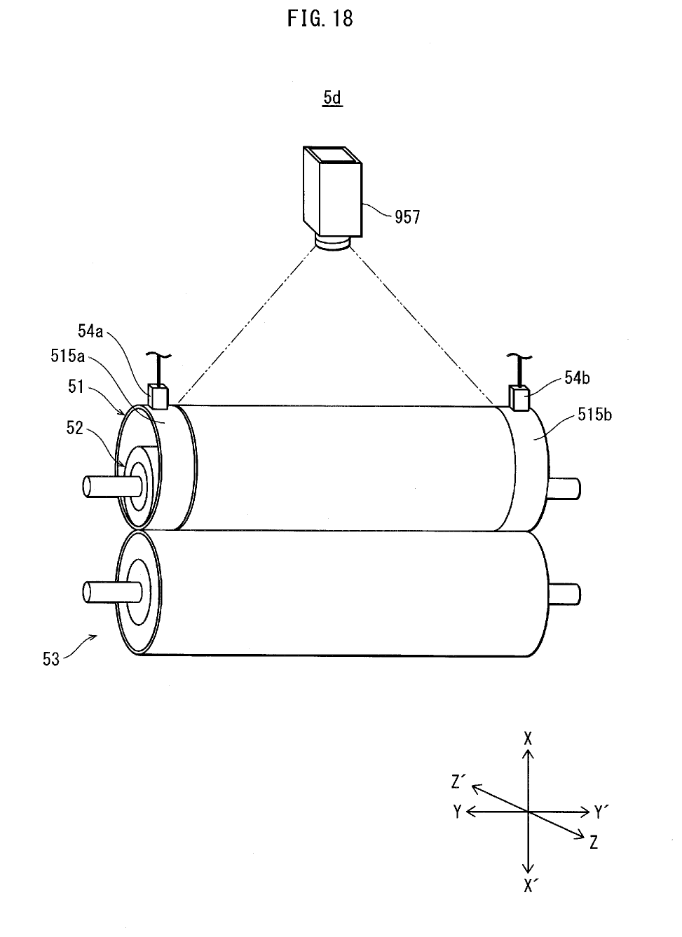

(5) In Embodiment 1, a thermopile array is used as the temperature sensor 57, but as shown in FIG. 18, a thermoviewer 957 that can detect temperature in finer detail may for example be used.

The thermoviewer 957 has a sheet-shaped infrared detector and has higher resolution than a thermopile array. Since the thermoviewer 957 can detect temperatures equivalent to the temperature in an abnormally hot section, the thermoviewer 957 can accurately detect the occurrence of an abnormally hot section.

(6) In Embodiments 1 and 2, the pressure roller 52 is provided on the inside of the running path of the fixing belt 51 so as to have play. Alternatively, the pressure roller 52 may be provided on the inside of the running path of the fixing belt 51 without play. In other words, any structure in which a resistance heating layer is formed on a heating rotating body may be adopted.

(7) In Embodiments 1 and 2, the fixing belt 51 is sandwiched by two rotating bodies, namely the pressure roller 52 and the pressing roller 53, to form the fixing nip. However, a structure may be adopted in which only one of these components is a rotating body, with the other component being a fixed elongated member that does not rotate.

(8) In Embodiments 1 and 2, an example is described in which an image forming apparatus according to an aspect of the present invention is a monochrome printer, but the present invention is not limited in this way. For example, the image forming apparatus may be a tandem-type color digital printer. In sum, the present invention may be adopted generally in any fixing device in which at least one of a first and a second pressing member rotates, the first pressing member is provided on the inside of the running path of a fixing belt, and a fixing nip is formed by the second pressing member pressing on the first pressing member with the fixing belt therebetween. The present invention may also be adopted in any image forming apparatus provided with such a fixing device.

The above embodiments and modifications may be combined with one another.

Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

What is claimed is:

1. A fixing device for thermally fixing an unfixed image formed on a recording sheet that passes through a nip, the nip being formed by a pressing member pressing against a circumferential surface of a heating rotating body that includes a resistance heating layer, the fixing device comprising:
a power supplier configured to supply power to the resistance heating layer;
a driver configured to rotate the heating rotating body;
a controller configured to control supply of the power by the power supplier; and
an abnormal heat detector configured to detect whether abnormal heat occurs anywhere along an entire surface of a heat-producing region within the heating rotating body, detection being performed during rotation of the heating rotating body, wherein
the controller causes the power supplier to stop supplying power to the resistance heating layer when the abnormal heat detector detects abnormal heat.

2. The fixing device of claim 1, wherein
the abnormal heat detector
includes a temperature detector configured to detect temperature over a temperature detection region that is shorter than the heat-producing region in a circumferential direction of the heating rotating body and at least as long as the heat-producing region in a direction of a rotation axis of the heating rotating body, and
detects whether abnormal heat occurs along the entire surface of the heat-producing region by the temperature detector detecting the temperature at predetermined intervals during one rotation of the heating rotating body.

3. The fixing device of claim 1, wherein
the abnormal heat detector includes a temperature detector configured to detect temperature over a temperature detection region that is shorter than the heat-producing region in a circumferential direction of the heating rotating body and shorter than the heat-producing region in a direction of a rotation axis of the heating rotating body,
the fixing device further comprises a reciprocator that periodically moves the temperature detector back and forth in the direction of the rotation axis, and
the abnormal heat detector detects whether abnormal heat occurs along the entire surface of the heat-producing region by the temperature detector detecting the temperature at predetermined intervals during rotation of the heating rotating body while the reciprocator moves the temperature detector back and forth.

4. The fixing device of claim 1, wherein
the abnormal heat detector includes a temperature detector configured to detect temperature over a temperature detection region that is shorter than the heat-producing region in a circumferential direction of the heating rotating body and shorter than the heat-producing region in a direction of a rotation axis of the heating rotating body,
the fixing device further comprises a detection direction changer configured to periodically change a direction of detection by the temperature detector with respect to the heating rotating body, the direction of detection being changed along the direction of the rotation axis, and
the abnormal heat detector detects whether abnormal heat occurs along the entire surface of the heat-producing region by the temperature detector detecting the temperature at predetermined intervals during rotation of the heating rotating body while the detection direction changer changes the direction of detection.

5. The fixing device of claim 2, wherein
the abnormal heat detector detects the occurrence of abnormal heat when a difference between consecutively detected temperatures is at least a predetermined value.

6. The fixing device of claim 2, wherein
the temperature detector detects temperature in each of a plurality of sections yielded by dividing up the entire surface of the heat-producing region in the direction of the rotation axis, and
the abnormal heat detector detects the occurrence of abnormal heat when a difference between temperatures detected in adjacent sections is at least a predetermined value.

7. The fixing device of claim 2, wherein
the abnormal heat detector detects the occurrence of abnormal heat when the detected temperature is at least a predetermined value.

8. The fixing device of claim 2, further comprising
a temperature measurement unit configured to measure a temperature of the heating rotating body at a predetermined location along a surface of the heating rotating body in order to adjust the temperature of the heating rotating body, wherein
the abnormal heat detector detects the occurrence of abnormal heat when a difference between the temperature detected by the temperature detector and the temperature measured by the temperature measurement unit is at least a predetermined value.

9. The fixing device of claim 1, wherein
the controller causes the power supplier to stop supplying power to the resistance heating layer when the heating rotating body stops rotating, regardless of whether the abnormal heat detector detects the occurrence of abnormal heat.

10. An image forming apparatus provided with a fixing device for thermally fixing an unfixed image formed on a recording sheet passing through a nip, the nip being formed by a pressing member pressing against a circumferential surface of a heating rotating body that includes a resistance heating layer, the fixing device comprising:
a power supplier configured to supply power to the resistance heating layer;
a driver configured to rotate the heating rotating body;
a controller configured to control supply of the power by the power supplier; and
an abnormal heat detector configured to detect whether abnormal heat occurs anywhere along an entire surface of a heat-producing region within the heating rotating body, detection being performed during rotation of the heating rotating body, wherein
the controller causes the power supplier to stop supplying power to the resistance heating layer when the abnormal heat detector detects abnormal heat.
